(19) United States
(12) Patent Application Publication
(10) Pub. No.: US 2018/0212494 A1
(43) Pub. Date: Jul. 26, 2018

(54) ELECTRICAL MACHINE

(71) Applicant: AVL LIST GMBH, GRAZ (AT)

(72) Inventors: ANDREAS SCHOCHLOW, REINHEIM (DE); BERNHARD AUMUELLER, EGGERSDORF (AT); WOLFGANG JOHANNES MUELLER, LUSTENAU (AT); REINHARD ROBITSCHKO, SCHWARZENBERG (AT); JUTTA KINDER, WEISSENSBERG (DE); ROBERTO SALVATO, HOECHST (AT)

(73) Assignee: AVL LIST GMBH, GRAZ (AT)

(21) Appl. No.: 15/745,716

(22) PCT Filed: Jul. 20, 2016
(86) PCT No.: PCT/EP2016/067235

§ 371 Date: Jan. 18, 2018

(30) Foreign Application Priority Data
Jul. 20, 2015 (AT) A 477/2015

(51) Int. Cl. H02K 9/22; H02K 1/20; H02K 5/15; H02K 7/00; H02K 7/08; H02K 9/10; H02K 9/19

(52) U.S. Cl. CPC H02K 9/22; H02K 1/20; H02K 5/15; H02K 9/19; H02K 7/083; H02K 9/10; H02K 7/003

(57) ABSTRACT

An electrical machine includes a stator, a rotor comprising a shaft, and at least one heat-conducting element. The rotor is arranged at least partially inside the stator. The shaft includes at least one opening on at least one front side and an axis of rotation. The at least one opening extends in one direction along the axis of rotation of the shaft. The at least one heat-conducting element is arranged in the at least one opening of the shaft. The at least one heat-conducting element is at least partially made of a material having a thermal conductivity which is higher than a material of the shaft.

### CROSS REFERENCE TO PRIOR APPLICATIONS

This application is a U.S. National Phase application under 35 U.S.C. § 371 of International Application No. PCT/EP2016/067235, filed on Jul. 20, 2016 and which claims benefit to Austrian Patent Application No. A 477/2015, filed on Jul. 20, 2015. The International Application was published in German on Jan. 26, 2017 as WO 2017/013144 A1 under PCT Article 21(2).

### FIELD

The present invention relates to an electrical machine comprising a stator and to a rotor having a shaft, the rotor being arranged at least partially inside the stator.

### BACKGROUND

The electrical machine can in principle be of any type or constructional size. It can in particular be a direct current machine or a three-phase machine, for example, an asynchronous or synchronous machine.

Electrical machines in the sense of the present invention serve to convert electrical energy into mechanical energy and/or vice versa. As a result of bearing losses, iron losses, ohmic losses, etc., such machines may heat up during operation. This heat will nominally be dissipated into the ambience by way of heat conduction in the component parts and/or via heat exchanger media such as, for example, air or other fluids (for example, cooling water), be conveyed from the interior of the machine to external components or systems which will recool the heat exchanger media, wherein the discharge of the heat generated within the machine can be particularly difficult and thus critical. For example, due to losses in the electrical rotor systems and in the rotor bearings, individual parts of the machine may develop an excessive temperature. The resultant temperature differences will cause mechanical deformation of individual components, which may impair the bearing functionality of rotors, particularly if the heat generated in the rotor is transferred onto the inner ring of a bearing and/or is generated due to frictional losses within the bearing. The temperature difference between the outer ring and the inner ring is often particularly high since the outer ring of such a bearing is normally accommodated in a cooler outer housing of the machine, and since the two bearing rings are spaced from each other by balls or rolls wetted by lubricant, and thus are hardly thermally connected to each other. The resultant mechanical deformation may lead to a markedly increased wear of the bearings. A high temperature of the rotor may further increase the electrical resistance of individual components of the machine, thus causing a deterioration of the efficiency of the machine.

The above outlined problems are particularly aggravating in electrical machines with high thermal exploitation as used in particular in test bench applications for component parts, in motors, and in the testing of power trains in the automobile sector.

### SUMMARY

An aspect of the present invention is to provide an electrical machine which has an improved temperature management.

In an embodiment, the present invention provides an electrical machine which includes a stator, a rotor comprising a shaft, and at least one heat-conducting element. The rotor is arranged at least partially inside the stator. The shaft includes at least one opening on at least one front side and an axis of rotation. The at least one opening extends in one direction along the axis of rotation of the shaft. The at least one heat-conducting element is arranged in the at least one opening of the shaft. The at least one heat-conducting element is at least partially made of a material having a thermal conductivity which is higher than a material of the shaft.

### BRIEF DESCRIPTION OF THE DRAWINGS

The present invention is described in greater detail below on the basis of embodiments and of the drawings in which:

FIG. 1 shows an electrical machine in a perspective view as seen obliquely from the front;

FIG. 2 shows electrical machine of FIG. 1 in a perspective view as seen obliquely from the rear;

FIG. 3 shows a sectional view of the electrical machine of FIG. 1;

FIG. 4 shows a detailed view of the front region on the drive side in the sectional view of FIG. 3;

FIG. 5 shows a detailed view of the rear region in the sectional view of FIG. 3;

FIG. 6 shows a perspective view of a first e exchanger element;

FIG. 7 shows a perspective view of a second heat exchanger element; and

FIG. 8 shows a perspective view of a rotor of the electrical machine of FIG. 1 inclusive of the bearings.

### DETAILED DESCRIPTION

The present invention makes it possible to provide an electrical machine which overcomes the above mentioned disadvantages and which allows for an improved heat distribution within the machine as well as an improved heat dissipation to the outside. The rotor temperature can thereby be lowered effectively. A well-aimed distribution of heat generated at the bearings is also made possible. A temperature management improved in such a manner will reduce the power loss of the machine and will preclude temperature-related increased wear of the bearings.

The shaft is the drive shaft of the rotor. To the extent the shaft is made of two or more than two different materials, the term “thermal conductivity of the shaft” in the sense of the present invention is to be understood as denoting a thermal conductivity value which is approximately formed substantially by averaging the thermal conductivity of the individual materials of the shaft, wherein consideration is given to the weight percentages or cross-section percentages of the individual materials. If, for example, a shaft consists of a material A by a weight percentage or cross-section percentage of 50%, a material B by a weight percentage or cross-section percentage of 25% and a material C by a weight percentage or cross-section percentage of 25%, the thermal conductivity of the shaft in the sense of the present invention will be 0.5a+0.25b+0.25c, with a, b and c representing the thermal conductivity of the materials A, B and C, respectively. It is significant that the heat-conducting elements have a higher thermal conductivity than the shaft so that the heat-conducting elements can make an effective contribution to the improvement of the thermal conductivity of the shaft. The openings do not necessarily have to extend parallel to the axis of rotation of the shaft but can also be arranged at an inclination. Typical values of the thermal conductivity of shafts are, for example, 15 W/mK for a chromium steel shaft and 45 W/mK for a conventional steel shaft. The thermal conductivity of shafts with aluminum is about 150 W/mK, and the thermal conductivity of shafts with copper is, for example, 400 W/mK.

The thermal conductivity of the heat-conducting elements can, for example, be at least 10%, 20%, 50%, 100%, 300% or 3000% higher than that of the shafts, wherein the thermal conductivity of the heat-conducting element can, for example, be at least 150 W/mK.

In order to achieve a particularly simple design of the electrical machine, it can be provided that the at least one opening extends parallel to the axis of rotation of the shaft.

The at least one opening and the heat-conducting element accommodated therein can, for example, have the same cross-sectional shape, for example, a circular cross section. A particularly effective heat-conducting transition between the heat-conducting element and the opening is thereby made possible and, at the same time, a good mechanical fit is realized. the shaft only comprises a sole opening, this opening should be arranged concentrically (and coaxially, respectively) to the axis of rotation of the shaft.

For obtaining a particularly simple and stable mechanical design of the shaft and the heat-conducting elements accommodated therein, it can he provided that the at least one heat-conducting element is loosely fitted into the at least one opening. A loose fit in the framework of the present disclosure is to he understood as an arrangement in which one element (i.e., the heat-conducting element) is held in a corresponding opening so that the element can be inserted into, and removed from, the opening without application of a large force. In case of openings having a diameter of, for example, 5 mm, the diameter of the heat-conducting element accommodated therein can, for example, be 4.8 to 4.9 mm.

It can in particular be provided that the shaft comprises at least two or more openings, each having at least one heat-conducting element inserted therein. It can be favorable in this respect to arrange the openings so that the common geometric center of gravity of the heat-conducting elements arranged therein is situated on the axis of rotation of the shaft. For this reason, the heat-conducting elements can, for example, be arranged concentrically to the axis of rotation of the shaft, thereby making it possible to preclude an imbalance of the assembly consisting of the shaft and the heat-conducting elements accommodated therein.

For attaining a particularly high thermal conductivity in the region of the surface of the shaft, it can be provided that the openings are arranged in an outer area of the shaft that extends at a distance of R/2 to R from the center of the shaft, with R being the radius of the shaft.

It can in particular be provided that the heat-conducting elements are fixed within the openings with the aid of an adhesive connection and/or a thermally conductive paste. The adhesive agent used for the adhesive connection can, for example, be an adhesive agent having enhanced heat-conducting properties.

It can be of particular advantage if the heat-conducting elements are made of copper, copper alloys and/or aluminum.

For particularly efficient dissipation of heat generated in shaft bearings, it can be provided that the at least one opening and/or the heat-conducting elements extend from the first or second end side of the shaft along the axis of rotation in the direction of the opposite second or first end side at least up to the region of the shaft bearings assigned to the first or the second end side. In this arrangement, the openings and the heat-conducting elements are arranged so that the bend-critical rotational speed of the shaft will not be substantially reduced. The openings as well as the heat-conducting elements therefore extend into the interior of the machine only by a distance that is allowable and respectively reasonable in consideration of the influence on the two parameters a) bend-critical rotational speed and b) improved heat dissipation.

It can be of particular advantage if the at least one opening and/or the at least one heat-conducting element extend from the first or the second end side of the shaft along the axis of rotation in the direction of the opposite second or first end side at least up a rotor pack of the rotor.

The explanations given in the framework of this disclosure in the context of the at least one opening and/or the at least one heat-conducting element can of course also apply to a plurality of openings and/or heat-conducting elements, particularly to all openings and/or heat-conducting elements. The rotor pack of the rotor is normally that part of the rotor which contains electric windings, rotor bars (in asynchronous machines) and/or permanent magnets which, for developing a mechanical moment of rotation, interact with the stator field.

It can in particular be provided that the at least one opening and/or the at least one heat-conducting element extend into a part of the shaft that is arranged within the rotor pack.

For facilitating the insertion of the heat-conducting elements into the shaft, it can be provided that the at least one opening comprises a bore passing through the shaft toward the outside, for example, in a radial direction, wherein the bore can, for example, be arranged in an end region of the opening facing away from the end side, which end region is free of heat-conducting elements. By the insertion of the heat-conducting element, excess air and thermally conducting paste or adhesive can escape through the bore so that the heat-conducting element, once inserted into the opening, is held in a defined position. The bore can, for example, be provided at such a site of the shaft so that, also after insertion of the heat-conducting element, the bore is not be covered or closed by the heat-conducting element.

The heat-conducting elements can increase the thermal conductivity of the shaft in a particularly effective manner if the total cross-sectional area of the openings occupies a surface area portion of 5 to 50%, for example, 15 to 30%, for example, 15 to 20% of the cross-sectional area of the shaft.

A further aspect of the present invention relates to an electrical machine comprising a stator and a rotor which is arranged at least partially inside the stator, wherein the electrical machine comprises at least one heat exchanger device having at least one first heat exchanger element connected to the rotor for common rotation therewith, and having at least one second heat exchanger element connected to the stator for common rotation therewith, wherein the first and the second heat exchanger element each comprise at least one heat exchanger surface, wherein the heat exchanger surfaces at least in a partial area extend from an end side of the rotor in a direction along the rotor, and the heat exchanger surfaces at least within the partial area are arranged opposite to each other in the radial direction of the rotor and are arranged concentrically to the axis of rotation of the rotor.

Via the heat exchanger device, heat can be dissipated in a particularly efficient manner from the interior of the machine either directly into the ambience or, by way of an indirect dissipation into the ambience, into a component part having the cooling medium flowing through it. This embodiment of the present invention can be freely combined with the above described variants of the present invention and will improve the temperature behavior of the electrical machine in a synergetic manner.

The heat exchanger surfaces can in principle be arranged opposite to each other in a radial direction continuously (not only in partial areas). A mutually opposite arrangement in an axial direction is also possible. The first heat exchanger element is arranged to rotate relative to the second heat exchanger element. A merely mutually opposite arrangement of the heat exchanger surfaces in the circumferential direction is excluded for this reason because such an arrangement would block a rotation of the heat exchanger elements relative to each other. “Mutually opposite heat exchanger surfaces” within the framework of the present invention means, unless indicated otherwise, that the heat exchanger surfaces of the first heat exchanger element are opposite to the heat exchanger surfaces of the second heat exchanger element.

It can in particular be provided that the first heat exchanger element and/or the second heat exchanger element comprise at least one, for example, two or more projections having at least partially an annular shape, wherein the heat exchanger surfaces are formed on the surface of the projections. The annular projections can have a shell- or a drum-like shape and are designed to enlarge the heat exchanger surfaces of the first and/or the second heat exchanger element.

It can be advantageous herein if individual projections of the first heat exchanger element extend into areas situated between the projections of the second heat exchanger element and/or vice versa. The first and the second heat exchanger element can, for example, be designed to largely have mutually corresponding, complementary shapes, thus allowing for a particularly effective heat exchange between the heat exchanger elements. For clarification of the term “shape”, it is to be noted in this context that the shape of an object is generally defined by the configuration of the surface of this object. The shape thus corresponds to a virtual enclosure coinciding with the surface of the object.

The first heat exchanger element, due to its connection with the rotor for common rotation therewith, will be subjected to the same rotational speeds as the rotor and to the associated centrifugal forces which might cause a deformation of the first heat exchanger element. For precluding such a deformation, the first heat exchanger element can, for example, be made of a (heat-conductive) material having a yield strength of at least 300 N/mm², for example, at least 400 N/mm². The thermal conductivity can be at least 100 W/mK. The rotational speeds of the rotor of the electrical machine will be determined in dependence on the desired output and the desired moment of rotation and are typically in the range from a several 100 rpm to above 20,000 rpm.

It can be of particular advantage if the first heat exchanger element is made of aluminum, for example, of EN AW-7075 which has a particularly high yield strength in combination with good thermal conductivity.

The second heat exchanger element can advantageously be made of aluminum, copper and/or of copper alloys such as, for example, brass or bronze, wherein aluminum can be machine-processed more easily than copper.

The heat exchanger device can be an interior heat exchanger device which is between two cover elements of the electrical machine that are disposed at the end side and are fixedly connected to the stator, wherein the first heat exchanger element of the inner heat exchanger device is fastened at an end side of a rotor pack and is thermally connected to the rotor pack, and the second heat exchanger element of the inner heat exchanger device is fastened to the adjacent cover element and is thermally connected thereto.

The cover elements at least partially close the end faces of the electrical machine, there being enclosed an interior space of the machine that is situated between the cover elements, while the interior space accommodates the rotor pack of the rotor in its entirety.

Alternatively and/or additionally thereto, an outer heat exchanger device can be provided, wherein the first heat exchanger element of the outer heat exchanger device is mechanically and thermally connected to the shaft of the rotor, and the second heat exchanger element is fastened and thermally connected to a cover element that is arranged on an end side of the electrical machine and is fixedly connected to the stator.

It can be of particular advantage if the respective cover element is a bearing shield, wherein the bearing shield accommodates therein at least one bearing for supporting the shaft of the rotor. Typically, on the drive side, the bearing is a fixed bearing and, on the opposite side, it is a floating bearing, wherein the bearing arrangement on each side can consist of at least one bearing but also of a plurality of bearings arranged adjacent to each other.

In an embodiment of the present invention, the second heat exchanger element of the outer heat exchanger device can, for example, be arranged on the bearing shield, wherein, for example, the second heat exchanger element comprises an abutment face via which a bearing accommodated in the bearing shield is secured against displacement in the direction of the axis of rotation of the shaft.

The heat exchanger device(s), particularly the inner and/or outer heat exchanger device(s), can be arranged on the drive side and/or on the opposite rear side of the electrical machine. A total of up to four heat exchanger devices, i.e., two inner and two outer heat exchanger devices, can thus be arranged on the electrical machine.

For improving the thermal behavior of an electrical machine, the stator can comprise at least one jacket cooling device or be connected thereto, wherein the jacket cooling device can, for example, comprise cooling ribs for air cooling and/or a water-cooled cooling circuit. In such an arrangement, the heat-conducting elements and/or the heat exchanger elements of the present invention can be used in a particularly effective manner because, by the provision of the jacket cooling device, the temperature differences within the machine can be considerably high.

The present invention will be explained in greater detail below by way of several exemplary and non-limiting embodiments which are illustrated in the drawings.

Identical reference numerals will identify identical features unless indicated otherwise.

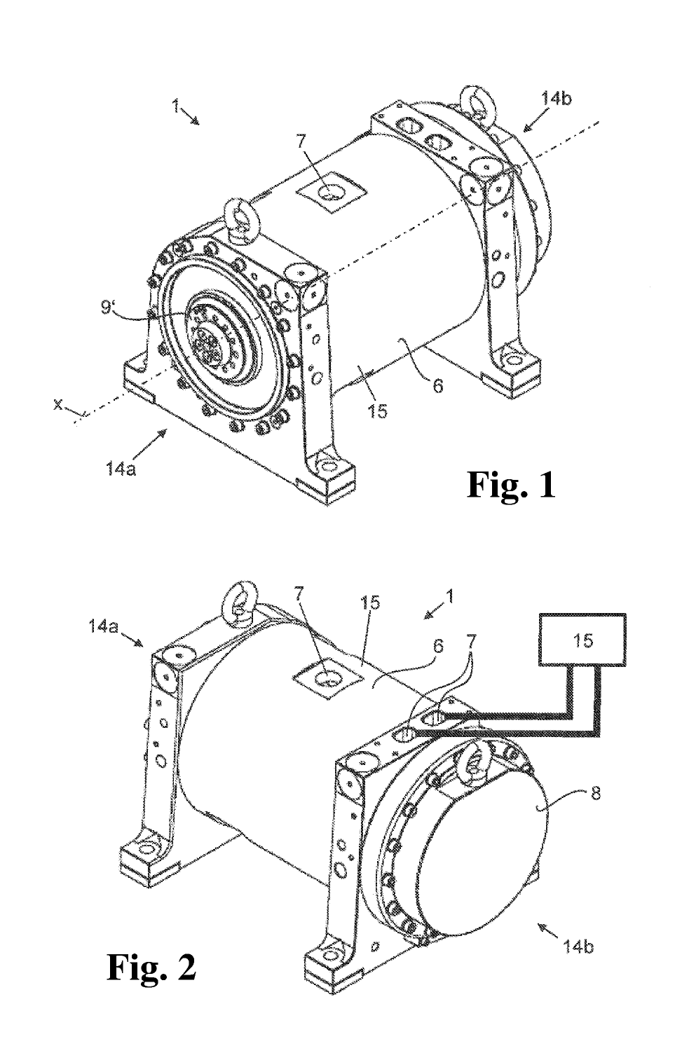

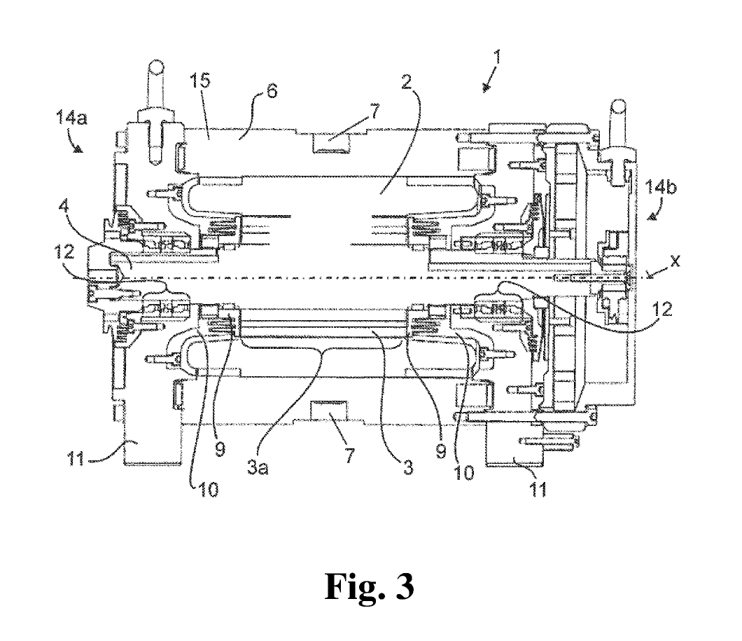

FIG. 1 shows an electrical machine 1 in perspective view as seen obliquely from the front, wherein, in the illustrated example, the electrical machine 1 is a synchronous electrical machine. As already mentioned initially, the electrical machine 1 could also be a direct current machine or an asynchronous machine. The electrical machine 1 comprises an enclosure 6, two mutually opposite end faces 14a and 14b and a first heat exchanger element 9′ which is connected, for common rotation, to a rotor 3 shown in FIG. 3 so as to be rotatable about the axis of rotation x. The first end face 14a corresponds to the drive side of the electrical machine 1 whereas the second end face 14b shown in FIG. 2 represents the rear side of the machine 1. The rear side is dosed by a housing lid 8. The enclosure 6 is connected to, or provided with, an enclosure cooling device 15, particularly a water cooling circuit, there being shown corresponding inlets and outlets 7 for feed and discharge of the cooling medium. In the enclosure 6, which can be designed, for example, as a cooling enclosure made of aluminum, a large number of bores can be formed which extend along the entire length with diameter of about 16 mm and are arranged in the wall of enclosure 6. The bores can, for example, be alternately connected to each other on the end side by milled passages between respectively two bores (for example, bore 1 to bore 2 at the front, bore 2 to 3 at the rear, 3 to 4 at the front, etc.). At the top and at the bottom, the inlet and/or outlet 7 can be arranged in a central position. For example, the cooling water is fed in from below, then flows in a zigzag course through the machine, half of it to the left and the other half to the right, and flows out again at the top. In order to vent the enclosure cooling device 15 and to be able to consider local space conditions, the enclosure 6 can be provided with further inlets and outlets 7.

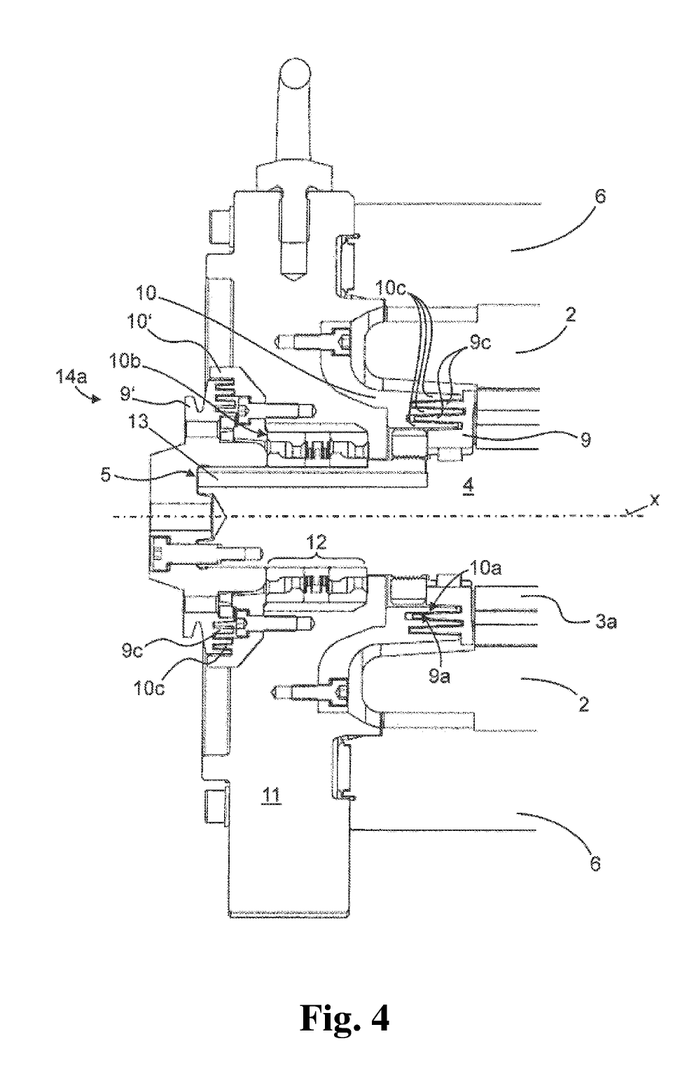

FIG. 3 shows a longitudinal sectional view of the electrical machine 1. FIG. 3 shows a stator 2 which is provided with windings (not shown in the drawings) for generating a magnetic field, particularly a rotary field. Internally of the stator 2 and beyond the same, a rotor 3 extends, wherein the rotor windings are arranged within the rotor pack 3a. The rotor pack 3a is delimited by two mutually confronting end faces, each of them having a first (inner) heat exchanger element 9 arranged thereon. Opposite to this first heat exchanger element 9, there is arranged a respective corresponding second (inner) heat exchanger element 10, where respective first and second heat exchanger elements 9 and 10 together form a heat exchanger device. In the illustrated exemplary embodiment, the first heat exchanger elements 9 fastened to the end side of the rotor pack 3a are connected, by way of a tongue-and-groove connection, to a shaft 4 of rotor 3 while, however, they can also be connected to rotor 3 for common rotation therewith in any other desired manner. The second heat exchanger elements 10 corresponding thereto are connected to the stator 2 for common rotation therewith and are each mounted to a cover element 11. Cover element 11 is formed as a bearing shell in which a bearing 12 for support of shaft 4 is accommodated. The cover elements 11 are fixedly connected to the stator 2 so that, via the cover elements 11, the second heat exchanger elements 10 are connected to stator 2 for common rotation therewith. Closer details of the arrangement of the heat exchanger elements 9 and 10 and of further component parts will be explained hereunder with reference to FIGS. 4 to 8.

FIG. 4 shows a detailed view of the front part of the electrical machine 1 on the drive side according to the sectional view of FIG. 3. As already mentioned, a first heat exchanger element 9 is thermally connected to an end side of rotor pack 3a wherein, opposite to the first heat exchanger element 9, a second heat exchanger element 10 is arranged which is connected to an inner side of cover element 11 facing toward rotor pack 3a. These two heat exchanger elements together form an inner heat exchanger device. For improving the heat transfer between the heat exchanger elements 9 and 10 and the rotor pack 3a and respectively the cover element 11, the transition region between the heat exchanger elements 9, 10 and the rotor pack 3a and respectively the cover element 11 can, for example, be provided with a heat-conducting paste.

Also to be seen in FIG. 4 is a further first (outer) heat exchanger element 9 which is connected to shaft 4 on an end side of shaft 4. A second (outer) heat exchanger element 10 corresponding thereto is arranged on the outer side of cover element 11 and is configured so that a bearing 12 accommodated in cover element 11 which is secured against detachment in an axial direction with the aid of an abutment face 10b of second heat exchanger element 10. The heat exchanger elements 9′ and 10′ arranged on the outer side of cover element 11 together firm an outer heat exchanger device. Unless indicated otherwise, the explanations given on the inner heat exchanger elements 9 and 10 also apply to the outer heat exchanger elements 9′ and 10′.

In the illustrated example, the second heat exchanger elements 10 and 10′ are connected in a stationary manner to the cover elements 11 by corresponding screw connections. The first heat exchanger elements 9, by contrast, will follow the rotary movement of rotor 3 and will transfer the thermal energy accumulated in shaft 4 and/or in rotor pack 3a into the respective opposite heat exchanger element 10 which in turn will transfer the heat into cover element 11. Cover element 11 normally has a lower temperature, particularly if the electrical machine 1 comprises an enclosure cooling device 15 connected to cover element 11.

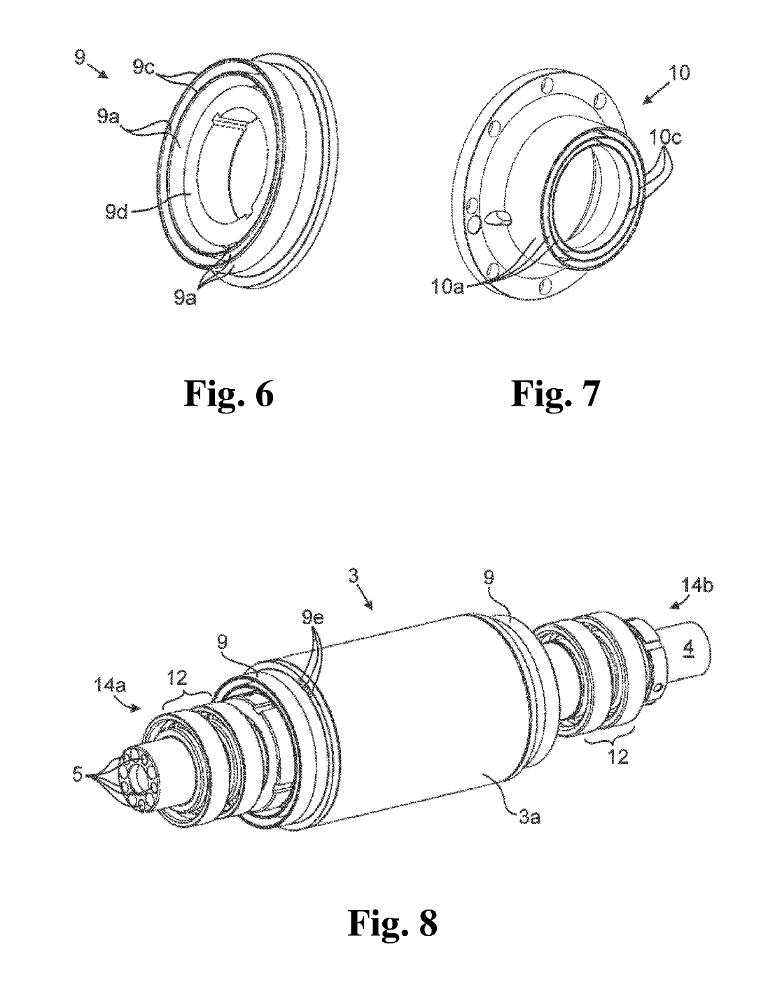

Heat exchange between the first and second heat exchanger elements 9 and respectively 9″ and 10 and respectively 10′ takes place via the heat exchanger surfaces 9a and respectively 10a (for ease of reference, in FIG. 4, only one respective surface of the inner heat exchanger device has been provided with a reference numeral, while FIGS. 6 and 7 show a more-detailed view in the outer heat exchanger device, the surfaces are provided in an analogous manner) which at least in a partial area extend from an end side of rotor 3 in a direction along rotor 3 and, at least within the partial area, are arranged opposite to each other in the radial direction of rotor 3. The heat exchanger surfaces 9a and 10a are further arranged concentrically to the axis of rotation x of rotor 3 and respectively of shaft 4.

In the illustrated embodiment, the first and second heat exchanger elements 9 and 10 each comprise at least two annular projections 9c, 10c, wherein the heat exchanger surfaces 9a and 10a are formed on the surface of the annular projections 9c and 10c. The heat exchanger surfaces 9a and respectively 10a can, for example, extend along the entire surface of the annular projections 9c and respectively 10c. By way of alterative thereto, the heat exchanger surfaces 9a and respectively 10a can also extend along one or a plurality of individual sections of the surface of the annular projections 9c and respectively 10c.

In this arrangement, the heat exchanger elements 9 and 10 can, for example, be configured so that the annular projections 9c of the first heat exchanger element 9 extend into areas situated between the annular projections 10c of the second heat exchanger element 10 and/or vice versa. The heat exchanger surfaces 9a and 10a do not contact each other and, depending on the dimensioning of the electrical machine 1 and of the heat exchanger elements 9 and 10, are spaced from each other by distances in the range from 0.3 mm to 10 mm, for example, from 0.3 mm and 2 mm. Between the heat exchanger surfaces 9 and 10, there exists a fluid and respectively medium, for example, air, wherein the heat transfer occurring between the surfaces by way of the fluid and respectively medium can be effected by convection. As already mentioned, the heat exchanger surfaces 10a of the second heat exchanger element 10 and the heat exchanger surfaces 9a of the first heat exchanger element 9 extend, in a partial area, from an end side of rotor 3 in a direction along rotor 3 wherein the heat exchanger surfaces 9a, 10a of this partial area are arranged opposite to each other in the radial direction of rotor 3 and are arranged concentrically to the axis of rotation of rotor 3. In this embodiment, the partial area comprises at least 50%, for example, at least 80%, of the extension of the heat exchanger surfaces 9a and 10a in the direction along rotor 3 and respectively in the axial direction x.

FIG. 4 further shows an opening 5 extending within shaft 4, the opening 5 running from the end side of shaft 4 in a direction along the axis of rotation x. Into this opening 5, there inserted at least one, for example, exactly one, heat-conducting element 13 made of a material having a higher thermal conductivity than the material of shaft 4. In the illustrated embodiment, opening 5 is situated in an outer area of shaft 4, the outer area extending at a distance of R/2 to R from the center of the shaft, with R being the radius of the shaft. The number of these openings 5 can in principle be freely selected and will primarily be dictated by the constructional and thermal demands toward the electrical machine 1. In the illustrated embodiment, there are provided, by way of example, five openings 5 with heat-conducting elements 13 accommodated in them.

The openings 5 and the heat-conducting elements 13 can, for example, extend beyond the bearing 12 and thus allow for well-aimed dissipation of heat losses of the bearings 12 which might cause problematic heating effects particularly on the inner ring of the bearing 12. In the illustrated exemplary embodiment, the openings 5 and the heat-conducting elements 13 terminate before the rotor pack 3a of rotor 3 but, alternatively thereto, could also extend along the shaft 4 up to within the rotor pack 3a so as to achieve a well-aimed dissipation to the outside of the power loss converted within the rotor pack 3a. This variant can be advantageous particularly in asynchronous machines in which the rotor power loss is generally higher than in synchronous machines with comparable nominal output.

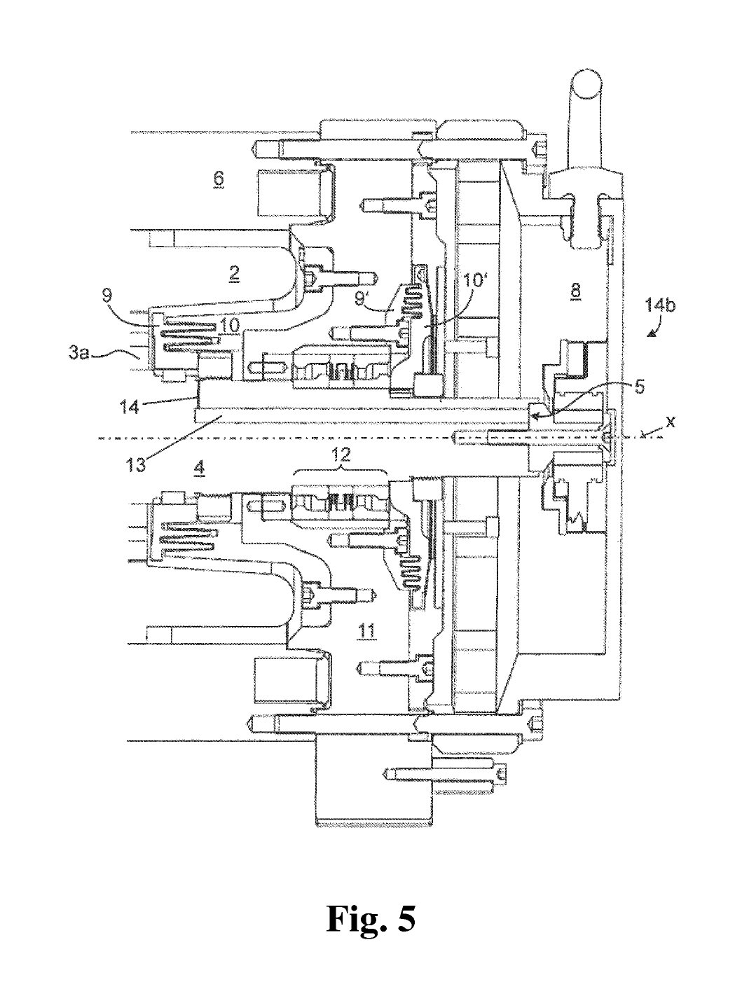

FIG. 5 shows a detailed view of the rear region on the back side in the sectional view of FIG. 3. The second end face 14b of the machine is facing away from the drive side and closed by the housing lid 8. Except for this, the mechanical design of the rear side of the electrical machine 1 according to the illustrated embodiment largely coincides with the design at the front side of machine 1. Thus, on the end of rotor pack 3 facing toward the rear side, the electrical machine 1 also comprises a first heat exchanger element 9 arranged opposite to a second heat exchanger element 10, wherein the second heat exchanger element 10 is mounted on the inner side of a cover element 11. The two heat exchanger elements 9 and 10 thus form an inner heat exchanger device as already described in conjunction with FIG. 4. Further in analogy to the arrangement in FIG. 4, an outer heat exchanger device is arranged on the outer side of rear-side cover element 11 and shaft 4. The shaft 4 also comprises openings 5 also on its rear-side end face, which openings 5 are designed to accommodate heat-conducting elements 13. The openings 5 (both on the front side and on the rear side of shaft 4) comprise a bore 14 passing through the shaft 4 to the outside, wherein the bore 14 is arranged in an end region of opening 5 facing away from the end side so that, during insertion of a heat-conducting element 13 into the opening 5, this end region allows for an escape of excess air, adhesive and/or heat-conducting paste.

FIG. 6 shows a perspective view of an exemplary first heat exchanger element 9 of an inner heat exchanger device. The first heat exchanger element 9 comprises two annular projections 9c, wherein heat exchanger surfaces 9a are formed on the inner and outer surface of the annular projections 9c. The first heat exchanger element 9 also comprises an inner fixing ring 9d which is formed with two mutually opposite groove-like recesses by which the first heat exchanger element 9 can be connected to shaft 4 for common rotation therewith. The recesses provide a positionally precise orientation of the first heat exchanger element 9 relative to shaft 4. This can he of considerable importance, for example, if the first heat exchanger element 9 is provided with corresponding balancing weights and/or comprises material losses, in order to compensate for an imbalance of the shaft. The inner fixing ring 9d comprises, on its outer side, an additional heat exchanger surfaces 9a so that the first heat exchanger element 9 in this embodiment includes a total of five heat exchanger surfaces 9a.

FIG. 7 shows a perspective view of a second heat exchanger element 10 corresponding to the first heat exchanger element 9 according to FIG. 6. This heat exchanger element 10 comprises three annular projections 10c arranged so that the projections 9c of the first heat exchanger element 9 can engage into the recesses formed between the projections 10c and can rotate therein. The mutually opposite heat exchanger elements 9 and 10 are thus, for example, shell-shaped or drum-shaped.

FIG. 8 shows a perspective view of the rotor 3 of the electrical machine 1 according to FIG. 1. FIG. 8 shows two first heat exchanger elements 9 which are arranged on the end faces of rotor pack 3a. In the first heat exchanger element 9 at the front on the drive side, balance openings 9e can be seen which are adapted for insertion of balancing weights (which are not shown) therein or which can be widened by enlargement of the bores and respectively will achieve a balance compensation by material reduction. Further, at the front end side of shaft 4, the openings 5 are clearly visible into which heat-conducting element 13 are inserted, the latter not being visible in FIG. 8. The bearings 12 can be any desired bearings known to the person skilled in the art that are suited for bearing support of shaft 4. These, as already mentioned above, can be fixed bearings or floating bearings. A fixed bearing can, for example, be arranged on one side of shaft 4, and a floating bearing on the opposite side so as to accommodate a thermal expansion of shaft 4 in axial direction.

Openings 5 and heat-conducting elements 13 and/or the heat exchanger devices can, for example, be dimensioned so that the maximal heat-up of the tube and/or the maximal inner bearing temperature can be lowered by at least 5 Kelvin, for example, at least 20 Kelvin, in comparison to a conventional design.

The heat-conducting elements 13 are inserted into the openings 5 with a loose fit. The openings 5 are arranged so that the common geometric center of gravity of the heat-conducting elements 13 arranged therein is situated on the axis of rotation x of shaft 4 and respectively rotor 3. The heat-conducting elements can, for example, fill the cross sectional area of the openings by at least 95%, for example, by 98% or 99% and, in an advantageous embodiment, are made of copper, copper alloys and/or aluminum. The heat-conducting elements 13 can, for example, be shaped as rods with circular cross section.

The present invention makes it possible, via the heat exchanger device and/or the heat-conducting elements 13, to reduce the rotor temperature and/or the bearing temperature. Attaining knowledge of this teaching, the expert will be able to envision other embodiments

1-19. (canceled)

20. An electrical machine comprising:
a stator;
a rotor comprising a shaft, the rotor being arranged at least partially inside the stator, the shaft comprising at least one opening on at least one front side and an axis of rotation, the at least one opening extending in one direction along the axis of rotation of the shaft; and
at least one heat-conducting element arranged in the at least one opening of the shaft,
wherein,
the at least one heat-conducting element is at least partially made of a material having a thermal conductivity which is higher than a material of the shaft.

21. The electrical machine as recited in claim 20, wherein the at least one opening extends parallel to the axis of rotation of the shaft.

22. The electrical machine as recited in claim 20, wherein the at least one opening and the at least one heat-conducting element arranged therein have a same cross-sectional shape.

23. The electrical machine as recited in claim 22, wherein the at least one heat-conducting element is arranged to loosely fit into the at least one opening.

24. The electrical machine as recited in claim 20, wherein,
the shaft comprises at least two openings, and
at least one of the at least one heat-conducting element is arranged in each of the at least two openings.

25. The electrical machine as recited in claim 24, wherein the at least two openings are arranged so that a common geometric center of gravity of the respective at least one heat-conducting element arranged therein is situated on the axis of rotation of the shaft.

26. The electrical machine as recited in claim 24, wherein the at least two openings are arranged in an outer area of the shaft that extends at a distance of R/2 to R from a center of the shaft, where R is a radius of the shaft.

27. The electrical machine as recited in claim 20, farther comprising:
bearings,
wherein,
the shaft further comprises a first end side and a second end side,
a bearing is assigned to the first end side of the shaft,
a bearing is assigned to the second end side of the shaft, and
at least one of the at least one opening and the at least one heat-conducting element extends from the first end side of the shaft along the axis of rotation in a direction of the second end side at least up to a region of the bearing assigned to the second end side, or
at least one of the at least one opening and the at least one heat-conducting element extends from the second end side of the shaft along the axis of rotation in a direction of the first end side at least up to a region of the bearing assigned to the first end side.

28. The electrical machine as recited in claim 20, wherein,
the at least one opening comprises a bore passing through the shaft toward an outside, and
the bore is arranged in an end region of the at least one opening which faces away from an end side which end side is free of the at least one heat-conducting element.

29. The electrical machine as recited in claim 20, wherein,
the at least one opening comprises a cross sectional area,
the shaft comprises a cross sectional area, and
the cross-sectional area of the at least one opening is 5 to 50% of the cross-sectional area of the shaft.

30. The electrical machine as recited in claim 20, further comprising:
at least one heat exchanger device comprising at least one first heat exchanger element which is connected to the rotor for common rotation therewith and at least one second heat exchanger element which is connected to the stator for common rotation therewith,
wherein,
the at least one first heat exchanger element comprises at least one heat exchanger surface and the at least one second heat exchanger element comprises at least one heat exchanger surface,
each of the at least one heat exchanger surface at least in a partial area extends from an end side of the rotor in a direction along the rotor, and
the at least one heat exchanger surfaces, at least within the partial area are arranged opposite to each other in a radial direction of the rotor and are arranged concentrically to the axis of rotation of the rotor.

31. The electrical machine as recited in claim 30, wherein,
at least one of the at least one first heat exchanger element and the at least one second heat exchanger element comprises at least one projection which comprises an at least partially annular shape, and
the at least one heat exchanger surface is formed on a surface of the at least one projection.

32. The electrical machine as recited in claim 31, wherein,
the at least one first heat exchanger element comprises at least one projection which comprises an at least partially annular shape,
the at least one second heat exchanger element comprises at least one projection which comprises an at least partially annular shape, and,
at least one of,
the at least one projection of the first heat exchanger element extends into areas situated between the at least one projection of the second heat exchanger element, and
the at least one projection of the second heat exchanger element extends into areas situated between the at least one projection of the first heat exchanger element.

33. The electrical machine as recited in claim 30, further comprising:
two cover elements arranged at an end side fixedly connected to the stator; and
a rotor pack,
wherein,
the at least one heat exchanger device is provided as at least one inner heat exchanger device which is arranged between the two cover elements,
the at least one inner heat exchanger device comprises the at least one first heat exchanger element and the at least one second heat exchanger element,
the at least one first heat exchanger element is fastened at an end side of the rotor pack and is thermally connected to the rotor pack, and
the at least one second heat exchanger element of the at least one inner heat exchanger device is fastened to a cover element of the two cover elements which is adjacent and which is thermally connected thereto.

34. The electrical machine as recited in claim 33, wherein,
a cover element of the two cover elements is arranged on an end side of the electrical machine and is fixedly connected to the stator,
the at least one heat exchanger device is provided as at least one outer heat exchanger device which comprises the at least one first heat exchanger element and the at least one second heat exchanger element,
the at least one first heat exchanger element of the at least one outer heat exchanger device is mechanically and thermally connected to the shaft of the rotor, and
the at least one second heat exchanger element of the at least one outer heat exchanger device is fastened and thermally connected to the cover element.

35. The electrical machine as recited in claim to claim 34, further comprising:
at least one bearing configured to support the shaft of the rotor,
wherein,
the cover element is a bearing shield configured to accommodate the at least one bearing therein.

36. The electrical machine as recited in claim 35, wherein,
the at least one second heat exchanger element of the at least one outer eat exchanger device is arranged on the bearing shield, and
the at least one second heat exchanger element comprises an abutment face via which the at least one bearing accommodated in the bearing shield is secured against a displacement in a direction of the axis of rotation of the shaft.

37. The electrical machine as recited in claim 30, wherein the at least one heat exchanger device is arranged on at least one of a drive side and on an opposite rear side of the electrical machine.

38. The electrical machine as recited in claim 30, wherein,
the stator comprises at least one jacket cooling device or is connected thereto, and
the jacket cooling device comprises cooling ribs for at least one of an air cooled cooling circuit and a water-cooled cooling circuit.
